(19) United States
(12) Patent Application Publication
(10) Pub. No.: US 2010/0098885 A1
(43) Pub. Date: Apr. 22, 2010

(54) PLASMA SILANIZATION SUPPORT METHOD AND SYSTEM

(75) Inventors: John H. Vontell, Manchester, CT (US); Russell Lee Kam, San Jose, CA (US)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: UNITED TECHNOLOGIES CORPORATION, Hartford, CT (US)

(21) Appl. No.: 12/255,203

(22) Filed: Oct. 21, 2008

(51) Int. Cl. H05H 1/24; B05C 9/08

(52) U.S. Cl. 427/578; 118/620

(57) ABSTRACT

A plasma silanization system includes a processing vessel having a metal shelf and a non-metallic component support configured to elevate a component above the metal shelf to prevent excess silane deposition. A method of applying silane to a component in a plasma processing apparatus having a metal shelf includes placing a non-metallic component support on the metal shelf and placing a component on the non-metallic component support to prevent excess silane deposition.

### CROSS-REFERENCE TO RELATED APPLICATION(S)

This is a related application to U.S. patent application Ser. No. ______, filed on ______, 2008.

### STATEMENT OF GOVERNMENT INTEREST

The U.S. Government has a paid-up license in this invention and the right in limited circumstances to require the patent owner to license others on reasonable terms as provided for by the terms of Contract No. N00019-02-C-3003 awarded by the United States Navy.

### BACKGROUND

The present invention relates to a method and system for supporting a component during plasma silanization. More particularly, the present invention relates to a method and system for preventing excess silane deposition on component surfaces during plasma silanization.

Silanes are a class of chemical compounds containing silicon and hydrogen. Silane has the generic chemical formula of SiH₄ and is the silicon analog of methane. A silane is often applied to bonding surfaces of aircraft components, such as fan inlet shroud fairings, prior to bonding the component to a frame or other component. Different types of silanes are used to improve the bonding properties of components, whether they are for aircraft or other commercial uses. Silanes generally improve the strength and integrity of the bond between components.

### SUMMARY

One embodiment of the present invention relates to a method of applying silane to a component in a plasma processing apparatus having a metal shelf. The method includes placing a component support on the metal shelf and a component on the component support. The method further includes introducing a silane into the plasma processing apparatus and applying electromagnetic radiation within the plasma processing apparatus.

Another embodiment of the present invention relates to a silanization plasma system. The system includes a processing vessel having a metal shelf, an inlet for introducing silane and a power unit for applying electromagnetic radiation, and a component support configured to elevate a component above the metal shelf to prevent excess silane deposition.

### BRIEF DESCRIPTION OF THE DRAWINGS

FIG. 1 is a view showing the arrangement of a plasma processing apparatus.

FIG. 2 is a side view of a plasma silanization system.

FIG. 3 is an end view of a plasma silanization system component support.

FIG. 4 is an end view of a plasma silanization system.

FIG. 5 is a flow diagram showing one embodiment of a method of applying silane to a component in a plasma processing apparatus having a metal shelf.

### DETAILED DESCRIPTION

Recent advances in plasma technology have allowed engineers to apply a thin layer of silane to components using plasmas. Plasma silanization of a component is performed inside a plasma processing apparatus upon introduction of a silane into a processing vessel of the plasma processing apparatus and the application of electromagnetic radiation. The thin layer of silane offers the same functionality as the brushed on silane while providing additional advantages during application.

A thin layer of silane can be applied to a component using plasma technology. One method of applying a thin layer of silane to a component includes a multi-step process using plasmas. First, the component is placed in a plasma processing apparatus. Second, the component is “cleaned” with a plasma inside the apparatus. “Cleaning” refers to removing contaminants and weak boundary layers from the surface of the component. Suitable gases for cleaning include argon, oxygen, tetrafluoromethane, hydrogen and combinations thereof. Third, the component surfaces are “hydroxylated” with a plasma. “Hydroxylation” refers to the addition of hydroxyl (—OH) groups onto the surface of the component. Suitable hydroxylating agents include argon, water vapor, hydrogen peroxide, methanol and combinations thereof. Lastly, the component surfaces are “silanized” with a plasma. “Silanization” refers to the addition of a silane layer through self-assembly to the surface of the component. The type of silane chosen for bonding preparation depends on the adhesive used for bonding. Suitable vinyl silanes include vinyltrimethylsilane, vinyltrimethylethoxysilane, vinyldimethylethoxysilane, vinyltrimethoxypropylsilane and 3-aminopropylethoxysilane. The desired amount of silane applied to a component in preparation for bonding is thin (less than about 100 nm). Silane deposition in excess of about 100 nm is detrimental to adhesive bonding. Therefore, excess silane deposition is unwanted.

The present invention was developed while observing silane deposition behavior using plasma. Silane deposition using plasma is carried out in a processing vessel. Typically, processing vessels contain one or more metal shelves. Components that are treated within the processing vessel are generally placed on a metal shelf during operation. Applicants observed that when a component was located on one of the metal shelves within the processing vessel, excess silane was deposited on the component in the vicinity of the metal shelf. The excess silane was evidenced by a white, opaque band. The excess silane is undesirable for preparing components for subsequent bonding.

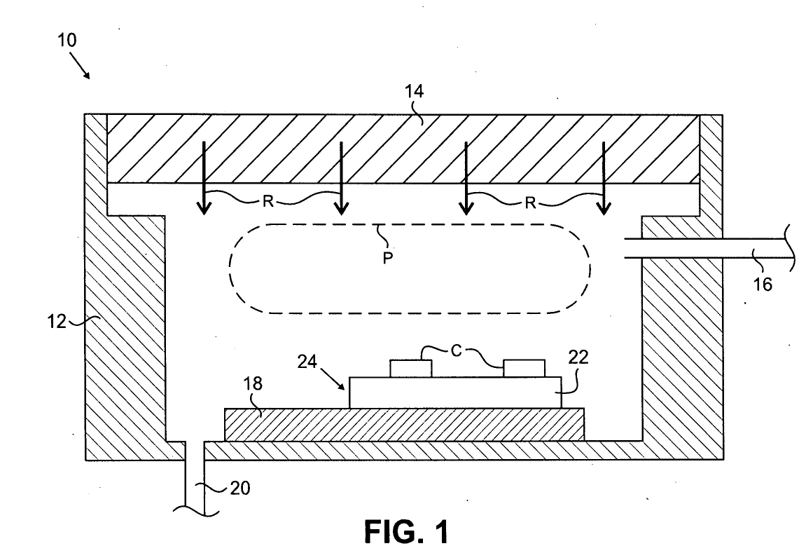

FIG. 1 illustrates one embodiment of plasma processing apparatus 10 capable of depositing a silane onto a component. Plasma processing apparatus 10 includes processing vessel 12, power unit 14, inlet 16, metal shelf 18, exhaust line 20 and non-metallic component support 22. Processing vessel 12 accommodates a component (work piece) C, such as a fan inlet shroud fairing, and processes the component C with a plasma. Power unit 14, when energized, generates electromagnetic radiation R thereby creating plasma P in processing vessel 12. Inlet 16 allows gases and silanes to enter processing vessel 12. Exhaust line 20 allows for vacuum evacuation of processing vessel 12. Metal shelf 18 supports component C.

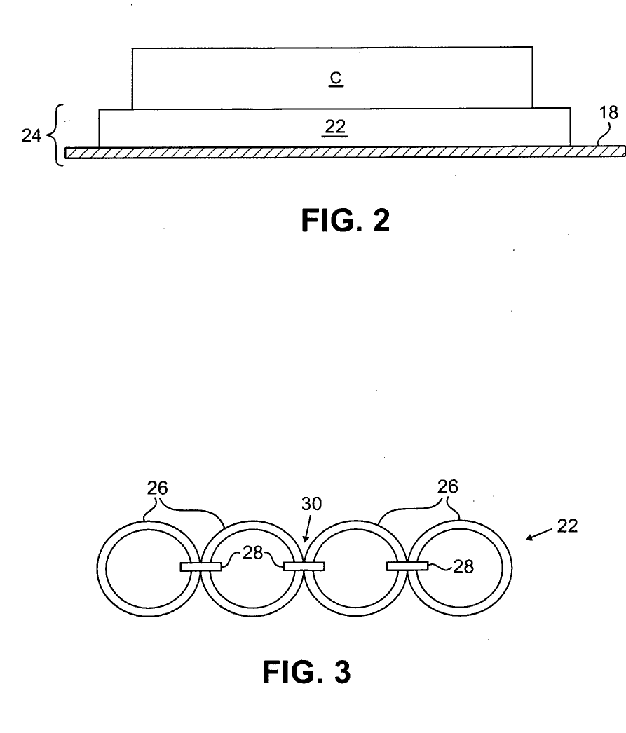

FIG. 2 illustrates a side view of one embodiment of plasma silanization system 24. Plasma silanization system 24 includes non-metallic component support 22 and metal shelf 18. Plasma silanization system 24 is located within processing vessel 12. Plasma silanization system 24 is illustrated supporting component C. Metal shelf 18 is typically stainless steel, but other metals that provide support within processing vessel 12 are also suitable.

Metal shelf 18 is a plasma field receptor. When component C and metal shelf 18 are located proximally, an increased level of silanization occurs on component C. Metal shelf 18 acts as a plasma field receptor and increases the rate of silane deposition on component C. The presence of a plasma field receptor in proximity to component C affects the electromagnetic field in the area of component C and causes increased chemical reactions between silanes and component C. The increased chemical reactions result in an increased rate of silane deposition onto component C during plasma silanization.

To prevent excess silane deposition, non-metallic component support 22 is located between metal shelf 18 and component C within processing vessel 12. Non-metallic component support 22 elevates component C above metal shelf 18. Non-metallic component support 22 functions as a plasma field isolator. A plasma field isolator inhibits the effect a plasma field receptor (here, metal shelf 18) has on a component by distancing the component from the plasma field receptor.

Non-metallic component support 22 is typically a plastic, polymer or composite material. As metallic materials function as plasma field receptors, non-metallic component support 22 is free of metal. Dyes and pigments often contain metal oxides as colorants. Thus, non-metallic component support 22 typically does not contain colorants. Such non-metallic component supports 22 may be “natural” plastics, polymers or composite materials. In an exemplary embodiment, non-metallic component support 22 is polyethylene and contains no colorants.

Various embodiments of non-metallic component support 22 have differing configurations. In exemplary embodiments, non-metallic component support 22 spaces component C from metal shelf 18 by at least about one-quarter of an inch (6.35 mm). Depending on the size of processing vessel 12, embodiments of non-metallic component support 22 can space component C from metal shelf 18 by one inch (2.54 cm) or more. Exemplary embodiments of non-metallic component support 22 also support component C so that component C is in a secure position and does not move during plasma silanization. One embodiment of non-metallic component support 22 supports multiple components C. An exemplary embodiment of such a non-metallic component support 22 supports components C in a repeated consistent manner. One exemplary embodiment of non-metallic component support 22 is also configured to provide minimal surface area contact with component C.

In one exemplary embodiment, non-metallic component support 22 is formed from a single piece of material. In an alternate exemplary embodiment, non-metallic component support 22 is formed from multiple pieces. FIG. 3 illustrates an end view of component support 22 composed of multiple segments. Non-metallic component support 22 includes a plurality of plastic tubes 26 attached by fasteners 28. Plastic tubes 26 are cylindrical tubes. In the embodiment illustrated in FIG. 3, plastic tubes 26 are hollow. In other embodiments, plastic tubes 26 are solid. Plastic tubes 26 are arranged side-by-side and adjacent plastic tubes 26 are fastened together by fasteners 28. In the embodiment illustrated in FIG. 3, fasteners 28 are cable ties (also known as zip ties). Fasteners 28 prevent movement of adjacent plastic tubes 26 in order to support components C. FIG. 3 illustrates one end of non-metallic component support 22 where plastic tubes 26 are attached by fasteners 28. At the opposite end of component support 22, additional fasteners 28 attach adjacent plastic tubes 26 to one another. Plastic tubes 26 have a diameter between about 2 inches (5.08 cm) and about 3 inches (7.62 cm). Adjacent plastic tubes 26 form groove 30 between plastic tubes 26. Groove 30 is configured to receive component C.

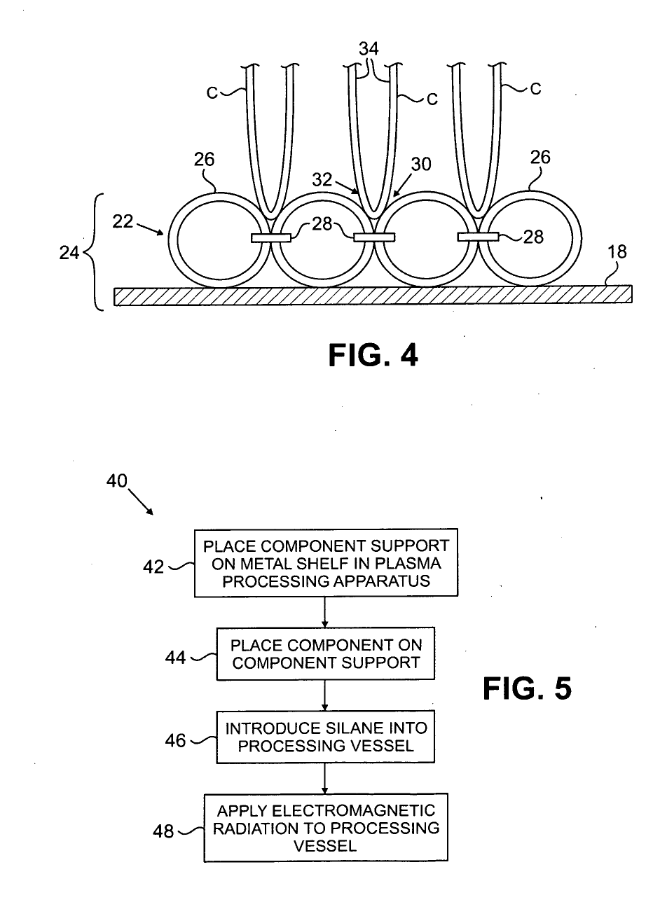

FIG. 4 illustrates one embodiment of plasma silanization system 24 where the non-metallic component support 22 of FIG. 3 supports three components C above metal shelf 18. In FIG. 4, components C are fan inlet shroud fairings. Components C have leading edges 32 located at a U-shaped bend. Leading edges 32 fit into grooves 30 and are supported by adjacent plastic tubes 26. Grooves 30 allow components C to be spaced along non-metallic component support 22. Components C are arranged into grooves 30 and spaced apart to allow silane plasma to come into contact with surfaces of components C that require preparation for bonding. Components C in FIG. 4 require silane preparation on interior surfaces 34. Contact between interior surfaces 34 and component support 22 is avoided due to the configuration of component support 22. Exterior surfaces of leading edges 32 directly contact non-metallic component support 22. The exterior surfaces of leading edges 32 do not require bonding preparation, so they are ideal areas for contact between components C and non-metallic component support 22.

Non-metallic component support 22 provides for a method of applying silane to a component in a processing vessel having a metal shelf. FIG. 5 illustrates a flow diagram showing the steps involved in one embodiment of a method 40 of applying silane to a component in a plasma processing apparatus having a metal shelf. Method 40 allows for proper deposition of silane on component C. In step 42 non-metallic component support 22 is placed on metal shelf 18 in processing vessel 12. Component support 22 is configured to elevate component C at least about one-quarter of an inch (6.35 mm) above metal shelf 18. In step 44 component C is placed on non-metallic component support 22. In step 46 a silane or mixture of silanes is introduced into processing vessel 12. In step 48 electromagnetic radiation is applied within processing vessel 12 to initiate plasma silanization. Additional silane may be introduced into processing vessel 12 during step 48. In some embodiments, step 46 occurs following introduction of oxygen, argon or a mixture of oxygen and argon and application of electromagnetic radiation. Steps 46 and 48 are typically performed for a predetermined length of time depending on the silane and the amount of electromagnetic radiation applied. Non-metallic component support 22 prevents excess silane deposition on component C during step 48 by acting as a plasma field isolator between component C and metal shelf 18.

In summary, the present invention relates to a method of supporting a component in a processing vessel to ensure an appropriate amount of silane deposition during plasma silanization. The method and system allow components to be silanized by a plasma without excess buildup of silane layers on the components. The present invention allows for adequate preparation of component surfaces for bonding using plasma silanization.

Although the present invention has been described with reference to exemplary embodiments, workers skilled in the art will recognize that changes may be made in form and detail without departing from the spirit and scope of the invention.

1. A method of applying silane to a component in a plasma processing apparatus having a metal shelf, the method comprising:
placing a non-metallic component support on the metal shelf, wherein the non-metallic component support is configured to elevate a component above the metal shelf to prevent excess silane deposition;
placing the component on the non-metallic component support;
introducing a silane into the plasma processing apparatus; and
applying electromagnetic radiation inside the plasma processing apparatus.

2. The method of claim 1, wherein the non-metallic component support is a plastic.

3. The method of claim 2, wherein the non-metallic component support is polyethylene.

4. The method of claim 1, wherein the non-metallic component support elevates the component at least about one-quarter inch above the metal shelf.

5. The method of claim 1, wherein the non-metallic component support is configured to support multiple components.

6. The method of claim 1, wherein the non-metallic component support comprises a plurality of attached tubes configured to support fan inlet shroud fairings.

7. A plasma silanization system comprising:
a processing vessel comprising:
a metal shelf;
an inlet for introducing a silane into the processing vessel; and
a power unit for applying electromagnetic radiation inside the processing vessel; and
a non-metallic component support, wherein the non-metallic component support is configured to elevate a component above the metal shelf to prevent excess silane deposition.

8. The silanization plasma system of claim 7, wherein the non-metallic component support is a plastic.

9. The silanization plasma system of claim 8, wherein the non-metallic component support is polyethylene.

10. The silanization plasma system of claim 7, wherein the non-metallic component support elevates the component at least about one-quarter inch above the metal shelf.

11. The silanization plasma system of claim 7, wherein the non-metallic component support is configured to support multiple components.

12. The silanization plasma system of claim 7, wherein the non-metallic component support comprises a plurality of attached tubes configured to support fan inlet shroud fairings.
